(19) United States
(12) Patent Application Publication
(10) Pub. No.: US 2016/0051343 A1
(43) Pub. Date: Feb. 25, 2016

(54) Kit of self-ligating brackets

(71) Applicant: Orthoarm, Inc., Toronto (CA)

(72) Inventor: John VOUDOURIS, Toronto (CA)

(21) Appl. No.: 14/831,496

(22) Filed: Aug. 20, 2015

Related U.S. Application Data
(60) Provisional application No. 62/039,623, filed on Aug. 20, 2014.

(51) Int. Cl. A61C 7/28

(52) U.S. Cl. CPC A61C 7/287

(57) ABSTRACT

A plurality of self-ligating orthodontic brackets for use in orthodontic treatment wherein varying progressive forces against an archwire occur. In one variant, the varying forces are a result of the angle of the locking shutter. In another variant, the varying forces are a result of the curvature of the locking shutter. In a third variant, the varying forces are a result of a combination of the two.

### RELATED APPLICATION DATA

This application claims priority from U.S. Provisional Application No. 62/039,623 filed on Aug. 20, 2014, and U.S. Provisional Application No. 62/112,957 filed on Feb. 6, 2015; all of which are herein incorporated by reference in their entirety.

### FIELD OF THE INVENTION

The present invention relates to the field of orthodontic brackets, and more particularly to biocompatible self-ligating brackets.

### BACKGROUND OF THE INVENTION

As is known, orthodontic treatment is effected by fixing small appliances called orthodontic brackets to a patient's teeth. Namely, the orthodontic brackets are most commonly used by being fixed to the patient's teeth in an appropriate manner so as to correct the misaligned teeth by applying an external force thereto through an arch wire extending between the fixed orthodontic brackets. As to the structure of these orthodontic brackets, they are constructed of a body having small slots and are adhered directly on the labial or lingual sides of the teeth or welded to such as metal bands attached to the teeth by cementing or by some other method.

It is well known that the front incisor teeth have single roots that are thin and that these roots are generally more tapered roots susceptible to root resorption or shortening during orthodontic treatment. Often times, when root resorption or shortening is observed in a patient with orthodontics, it is attributed to the magnitude of orthodontic force exerted on the roots by the braces.

In contrast, the middle premolar teeth have larger and thicker roots and the back molars have even larger, and multiple roots that can absorb the generally higher normal orthodontic forces for dental movement than the smaller front teeth. Heretofore, prior art orthodontics, and in particular, prior art self-ligating brackets have been unable to accommodate the varying root sizes and strengths to reduce the risk of root resorption and/or shortening during orthodontic treatment.

### SUMMARY OF THE INVENTION

In accordance with the invention there is provided a set of self-ligating orthodontic brackets that exert progressively lighter forces from the back molars to the front incisor teeth, by altering the angle at which a locking shutter engages an archwire used in the orthodontic treatment. The invention provides for a number of exemplary embodiments for effecting a set of orthodontic brackets having progressively lighter forces.

It is an object of the invention to provide a set of biocompatible self-ligating orthodontic brackets. It is a further object of the invention to provide a set of orthodontic brackets that are adaptable to exert different forces on different types of teeth to mitigate one or more of the problems with the prior art.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 shows a set of self-ligating brackets having a flat, angled locking shutter as contemplated by the invention.

FIG. 2 shows a set of self-ligating brackets having a curved locking shutter according to another embodiment of the invention.

FIGS. 3 to 5 shows a set of self-ligating brackets having a curved angled locking shutter according to another embodiment of the invention.

FIG. 6 shows occlusal view of the clip in a closed position where only the bottom end of the thin low profile and active clip is visible.

### DETAILED DESCRIPTION OF THE PREFERRED EMBODIMENTS

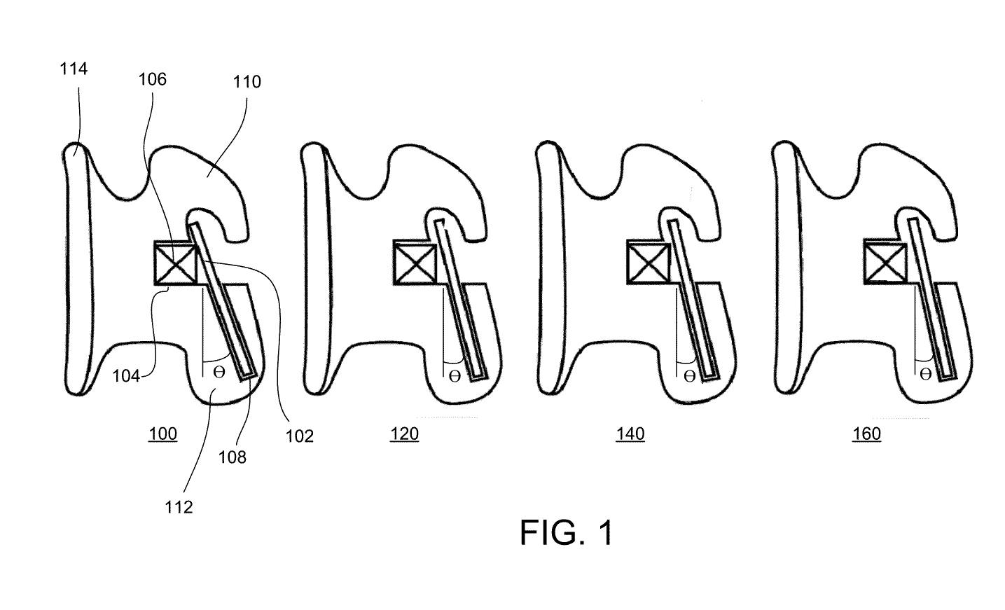

According to one embodiment of the invention, there is provided a set of self-ligating orthodontic brackets adapted to exert progressively lighter forces from the back of the mouth towards the front of the mouth, whereby the forces applied to the molar teeth are higher than those applied to the premolar teeth, which are themselves higher than those applied to the canines, which are themselves higher than those applied to the front incisor teeth. Referring now to FIG. 1, there is shown a set of such brackets. The general structure and arrangement of brackets according to the first embodiment is as disclosed in United States Patent Publication No. 2013/0260329 to John Voudouris, the contents of which are herein incorporated in their entirety by reference. In the '329 publication, an orthodontic bracket is shown having an angled locking shutter.

With reference to FIG. 1, the first embodiment of the invention provides for a set of these orthodontic brackets 100, 120, 140, 160. The brackets have a pair of gingival tie wings 110 and a pair of occlusal tie wings 112 shown in profile. A bonding pad 114 is used for attachment to the tooth (not shown). An archwire slot 104 extends mesio-distally across the body of the bracket permitting placement of an archwire 106 therein. The brackets in the set have the slidable locking shutter 102 placed in one or more tracks or channels 108 either internal to the occlusal tie wings 112 or on the exterior surface of the occlusal tie wings 112. The tracks 108 extend at progressively smaller angles, θ, such that a distance from the base of the archwire slot 104 to the locking shutter 102 in a direction perpendicular to the surface of the tooth is progressively greater from the molar bracket 100 to the premolars bracket 120 to the canine bracket 140, and to the incisors bracket 160. This arrangement in the kit provides for progressively lighter forces to be applied depending on the type of tooth, as illustrated in FIG. 1. In preferred embodiments, the slidable locking shutter 102 for the molar bracket 100 is angled between about 15-18 degrees from a straight vertical line perpendicular to a horizontal line to the bottom of the archwire slot 104 when viewed from the side as shown in FIG. 1. The locking shutter 102 associated with a premolar bracket 120 is angled between about 9-14 degrees, while the locking shutter 102 associated with the canine bracket 140 is angled between about 7-8 degrees, and finally the locking shutter 102 associated with the incisor bracket 160 is angled between about 1-7 degrees. All angular references are made with respect to the reference planes as earlier described.

Accordingly, as will be understood by a person skilled in the art, that in varying the angle, θ, of the locking shutter of the self-ligating brackets as described with respect to the first embodiment, as shown in FIG. 1, in a set or kit of orthodontic treatment brackets, varying forces can be placed on individual teeth to accommodate for different root sizes and thickness and therefore, mitigate the risk of root resorption.

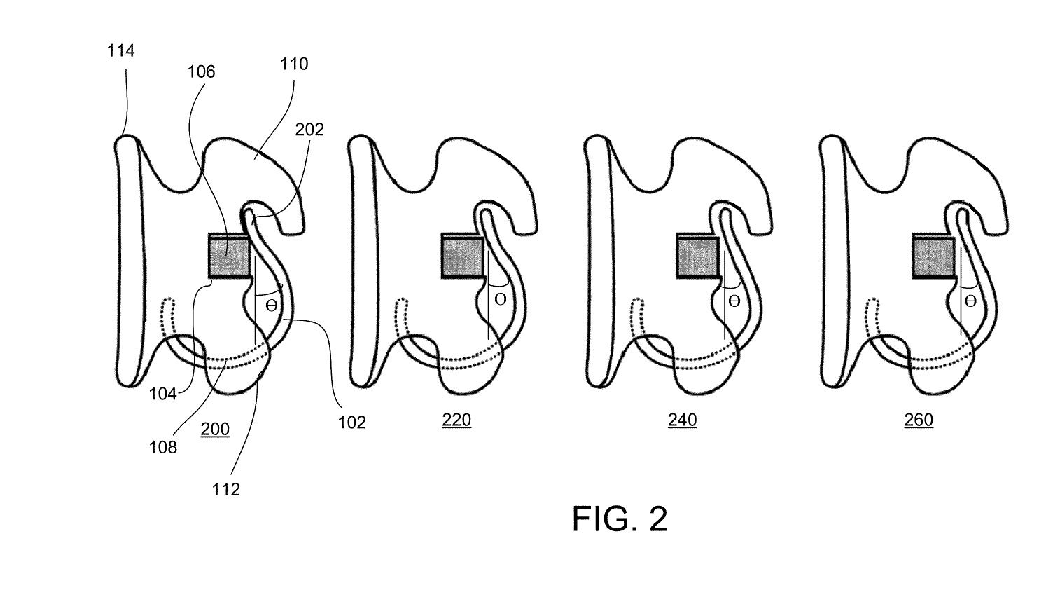

According to a second embodiment of the invention, as illustrated in FIG. 2, there is provided a set or kit of self-ligating brackets for orthodontic treatment having the general shape and structure as described in United States Patent Publication No. 2014/0134563 to OrthoArm, Inc., incorporated herein by reference. These brackets are of the structure having a curved locking shutter as described in the '563 publication, and in various prior applications. The general structure of this type of orthodontic bracket to which the invention is applied is also known in the art. The invention lies in the provision of brackets in a kit as herein described.

With reference to FIG. 2, the second embodiment of the invention provides for a set of these orthodontic brackets 200, 220, 240, 260. The brackets have gingival tie wings 110 and occlusal tie wings 112 and an archwire slot 104 having an archwire 106 therein. The brackets in the set have a curved locking shutter 102, having a clip portion 202 which engages the archwire 106 at progressively smaller angles, θ, such that a distance from the base of the archwire slot 104 to the clip portion 202 in a direction perpendicular to the surface of the tooth is progressively greater from the molars to the premolars to the canines, and to the incisors. This arrangement in the kit provides for progressively lighter forces to be applied depending on the type of tooth, as illustrated in FIG. 2. The shutter 102 passes through one or more channels 108 that retain the shutter 102 in the occlusal tie wings 112. In preferred embodiments, the locking shutter 102 for the molar bracket 200 has an end portion 202 that is angled between about 15-18 degrees from a straight vertical line perpendicular to a horizontal line to the bottom of the archwire slot 104 when viewed from the side as shown in FIG. 1. The locking shutter 102 associated with a premolar bracket 220 is angled between about 9-14 degrees, while the locking shutter 102 associated with the canine bracket 240 is angled between about 7-8 degrees, and finally the locking shutter associated with the incisor bracket 260 is angled between about 1-7 degrees. All angular references are made with respect to the reference planes as earlier described.

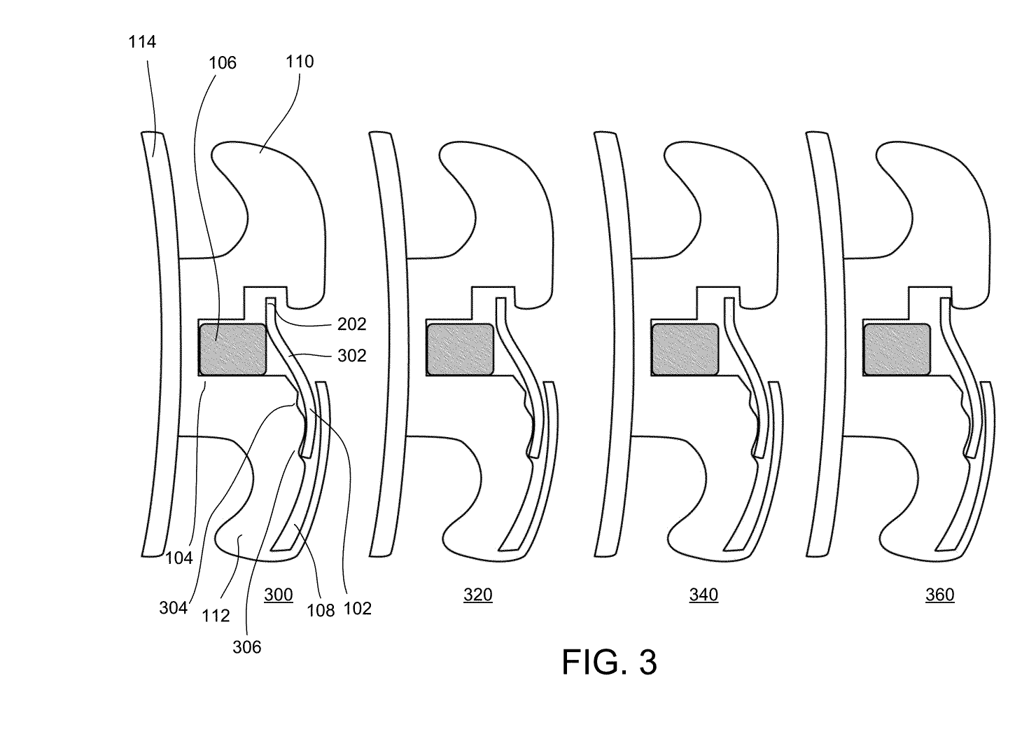

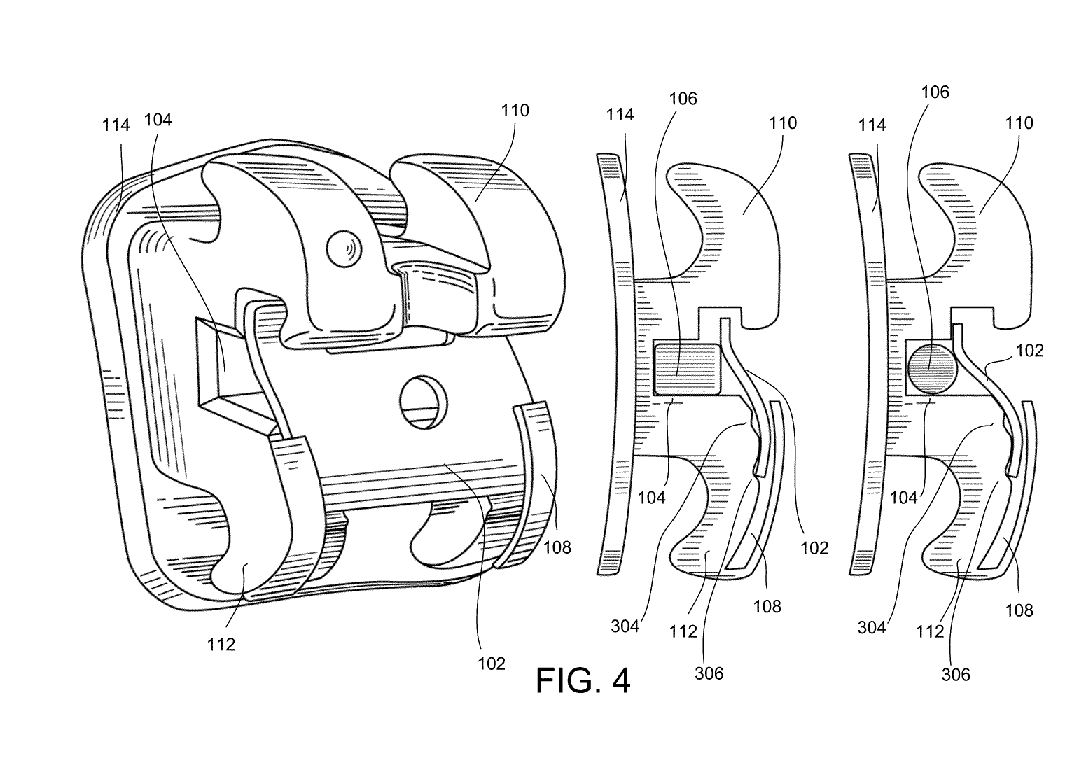

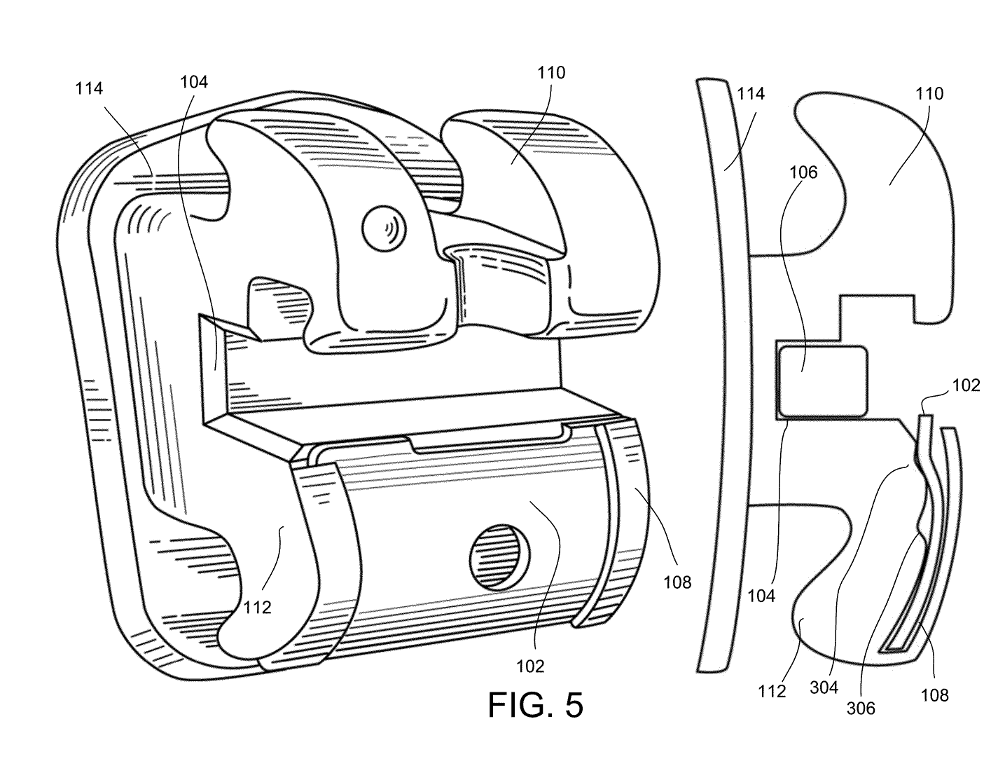

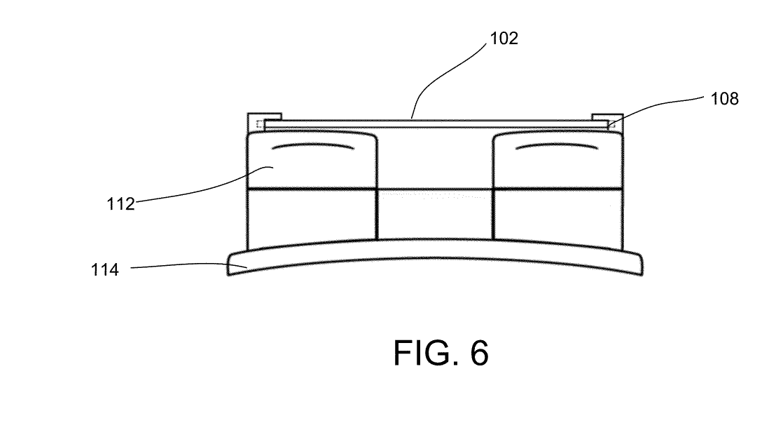

With reference to FIGS. 3 to 6, the third embodiment of the invention provides for a set of orthodontic brackets 300, 320, 340, 360 having a curved locking shutter 102 similar to the brackets of FIG. 2. Similar numbered elements have been omitted from brackets 320, 340, and 360 for clarity. The brackets in the set have a curved locking shutter 102 with a clip portion 202 and a curved portion 302. The curved portion 302 does not extend completely through the channel 108 towards the bonding pad 114 as in the second embodiment. The material between the bonding pad 114 and the archwire slot 104 is reduced or minimized in order to lower the profile of the brackets 300, 320, 340, 360 as more clearly shown in FIG. 6. The channels 108 may have one or more recesses 304 and 306 wherein the uppermost recess 304 holds the shutter 102 within the occlusal tie wing 112 while the shutter 102 is in an open position (shown in FIG. 5). The bottommost recess 306 holds the shutter 102 in position while the shutter 102 is in a closed position (shown in FIGS. 3 and 4).

Accordingly, various embodiments of the invention have been described above, that have the effect of a progressive, graduated force being applied on the dentition consistent with the respective root anatomy for more highly effective, efficient and biocompatible tooth movement that reduces the risk for root resorption. The invention is not limited to the embodiments herein described. Rather, variations on the above-described embodiments that produce a kit or set of self-ligating brackets for orthodontic treatments having clips that differ from each other to apply light, medium and normal forces to the front, middle and back teeth, respectively, are also contemplated by the invention.

1. (canceled)

2. Self-ligating orthodontic brackets for use in orthodontic treatment comprising at least two brackets; wherein each of said first and second brackets include a first and second locking shutter, respectively, for applying a force onto an archwire to effect orthodontic treatment; and wherein said first locking shutter is curved relative to a plane of said bracket to apply a first force and said second locking shutter is curved more or less than said first locking shutter so as to apply a second force greater or less than, respectively, said first force.

3. (canceled)

4. An orthodontic bracket comprising:
at least one occlusal tie wing having at least one channel therein;
at least one gingival tie wing;
an archwire slot between the at least one occlusal tie wing and the at least one gingival tie wing; and
the at least one channel angled towards the archwire slot by about 1-18 degrees.

5. The orthodontic bracket according to claim 4, wherein the at least one channel is angled towards the archwire slot by about 15-18 degrees.

6. The orthodontic bracket according to claim 4, wherein the at least one channel is angled towards the archwire slot by about 9-14 degrees.

7. The orthodontic bracket according to claim 4, wherein the at least one channel is angled towards the archwire slot by about 7-8 degrees.

8. The orthodontic bracket according to claim 4, wherein the at least one channel is angled towards the archwire slot by about 1-7 degrees.

9. The orthodontic bracket according to claim 4, further comprising a curved locking shutter.

10. The orthodontic bracket according to claim 9, wherein material between the archwire slot and a bonding pad has been minimized.

11. The orthodontic bracket according to claim 1, wherein material between the archwire slot and the bonding pad has been minimized.

12. A kit of orthodontic brackets comprising:
at least eight brackets comprising: at least one occlusal tie wing having at least one channel therein; at least one gingival tie wing; an archwire slot between the at least one occlusal tie wing and the at least one gingival tie wing; and the at least one channel angled towards the archwire slot by about 15-18 degrees;
eight brackets comprising: at least one occlusal tie wing having at least one channel therein; at least one gingival tie wing; an archwire slot between the at least one occlusal tie wing and the at least one gingival tie wing; and the at least one channel angled towards the archwire slot by about 9-14 degrees;
four brackets comprising: at least one occlusal tie wing having at least one channel therein; at least one gingival tie wing; an archwire slot between the at least one occlusal tie wing and the at least one gingival tie wing; and the at least one channel angled towards the archwire slot by about 7-8 degrees; and
eight brackets comprising: at least one occlusal tie wing having at least one channel therein; at least one gingival tie wing; an archwire slot between the at least one occlusal tie wing and the at least one gingival tie wing; and the at least one channel angled towards the archwire slot by about 1-7 degrees.
